(19) United States
(12) Patent Application Publication
(10) Pub. No.: US 2006/0065027 A1
(43) Pub. Date: Mar. 30, 2006

(54) Two-piece electronic lock door handle

(75) Inventor: Mark G. Valentine, Torrance, CA (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: U-Code, Inc., Torrance, CA (US)

(21) Appl. No.: 10/952,988

(22) Filed: Sep. 29, 2004

(51) Int. Cl. E05B 13/10

(52) U.S. Cl. 70/278.1; 70/214

(57) ABSTRACT

A digital keypad coded entry electronic lock is provided for operating an electronically operated door bolt locking mechanism within a closure or safe. The digital input handle is provided in two parts, with an upper head part positioning the keypad away from a depending handle part. Insertion and removal of an electronic storage battery is facilitated by providing an open rear portion of the handle through which the battery can be inserted or removed without the need for screws, pins or tools.

### RELATED APPLICATIONS

This application relates to the following applications of the present Applicant. ELECTRONIC INPUT AND KEYPAD ENTRY LOCK (U.S. Ser. No. 09/611,927, field Jul. 7, 2000, which is a divisional of U.S. Ser. No. 08/627,799 filed Mar. 29, 1966 now U.S. Pat. No. 6,116,061, which is a continuation of U.S. Ser. No. 08/219,785, filed Mar. 30, 1994 and now abandoned; COMBINATION LOCK WITH TERMINALS FOR OPERATION WITH AN ADDITIONAL BATTERY COMPARTMENT, U.S. Design Pat. No. D461,111 and COMBINATION LOCK HANDLE, U.S. Pat. No. 6,378,344. The contents of these applications are incorporated by reference herein.

### BACKGROUND OF THE INVENTION

1. Field of the Invention

This invention relates to a digital keypad associated electronic lock, having the keypad associated with a handle exteriorly of a closure door, such a safe, to operate an electronically operated door bolt locking mechanism associated with the closure.

2. General Background and State of the Art

Digital keypad operated lock mechanisms may be employed in secure containers and safes, by way of example, to facilitate locking or unlocking of the closure or safe door by simply turning the handle after entry of predetermined digital keypad entered code.

### SUMMARY OF THE INVENTION

The present invention discloses and provides a digital keypad coded entry for operating a door bolt locking mechanism within an associated closure or safe. The handle construction of the present invention and disclosure is particularly advantageous and being provided in a simple two-part construction. A front shell of the handle places the digital keypad upwardly at a head portion in circular configuration, where it is well out of the way of an operator's grasping a depending handle portion for moving the handle between open and closed positions after entry of a correct digital keypad code. In this manner, an operator's hand, when grasping a grip portion of the front shell of an exemplary handle, will not overlie any portion of the keypad so as to facilitate completion of a keypad code entry prior to turning of the handle. The current two-part handle construction facilitates this overall arrangement of simplicity and economy in manufacturing the handle construction. The depending portion of the handle is spaced from the associated closure door or safe, so as to facilitate grasping the lower portion of the handle without interference by the operator's handle with the digital keypad provided.

The digital keypad entry system of the present invention is facilitated by the use of an easily available power source, which is inserted and removed without the need for any additional screws, pins or tools. The current invention and disclosure provide an easily accessible battery pack insertion and removal method, which is manipulatable completely by an operator accessing a rear shell portion of the current two-part handle construction. A first battery housing aperture is provided for the operator to digitally contact and manipulate the exemplary battery, while an open second battery housing aperture is provided to facilitate simple insertion and removal of the battery. An upwardly inclined rib is also provided in the exemplary embodiment to hold an inserted battery in place until an operator chooses to simply slide the battery down and out of the rear shell over the associated rib.

### BRIEF DESCRIPTION OF THE DRAWINGS

FIG. 1 is a plan view, partially schematic, showing a safe door having an exemplary electronic combination lock input dial adapted to lock a pair of associated bolts, which interact with the safe.

FIG. 2 is a vertical view of the electronic combination lock input handle of the present invention.

FIG. 3 is a side elevational view of the input pad of FIG. 2 showing a spindle interconnection with internal safe bolt works.

FIG. 4 is a rear elevational view of the exemplary two-part handle of FIGS. 1-3, showing an open area for insertion of a battery pack, which is seen in phantom line.

FIG. 5 is a perspective side view of the two-part handle of FIG. 5, showing the associated battery pack in an assembled position of use in phantom line.

FIG. 6 is a perspective view, as in FIG. 5, showing a procedure for removal of the easily accessible battery pack shown in phantom line.

### DETAILED DESCRIPTION OF THE PREFERRED EMBODIMENT

The present invention generally follows the disclosure of U.S. Pat. No. 6,378,344, with a distinct improvement in the shape of the handle, is being provided in two parts, and the ease with which the battery pack can be inserted and removed. The disclosure of the '344 patent is fully incorporated herein by this reference.

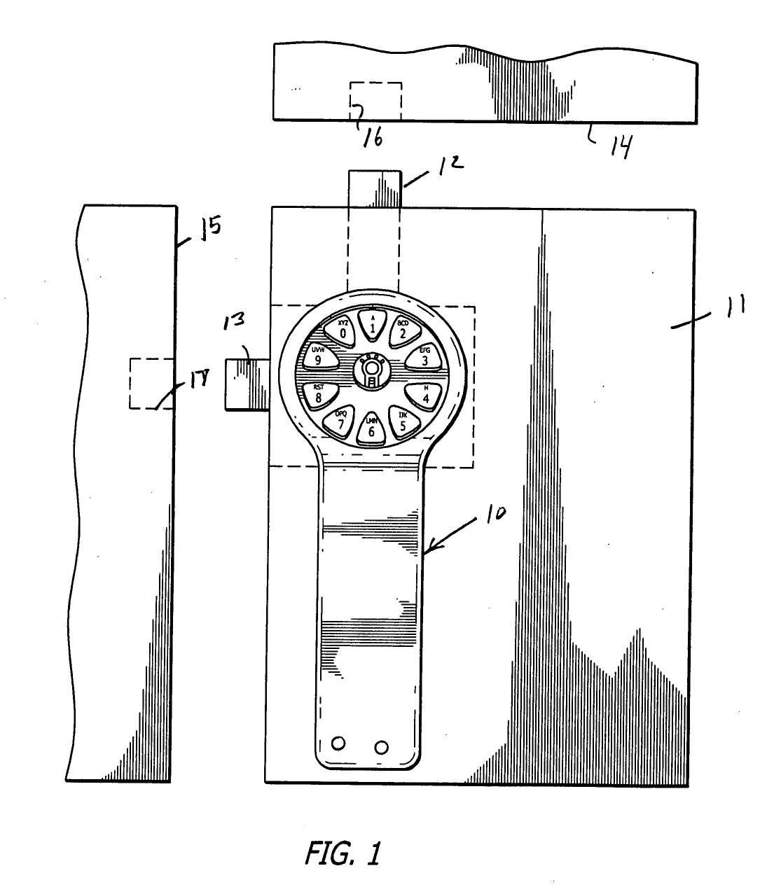

As seen in FIG. 1, the exemplary handle indicated generally at 10 is mounted to the face of a safe door for limited turning left and right to lock and unlock associated bolts, including other bolt 12 and side bolt 13 in the exemplary embodiment. The safe is provided in known manner, with an upper doorjamb 14 and a side doorjamb 15, having bolt-receiving apertures 16 and 17, respectively, in the exemplary embodiment. The digital keypad handle, indicated generally at 10, is thus associated with the exterior of an exemplary door of a locking mechanism, such a safe, with an electrically operated door bolt locking mechanism of known construction, associated with the door interiorly of the lockable container.

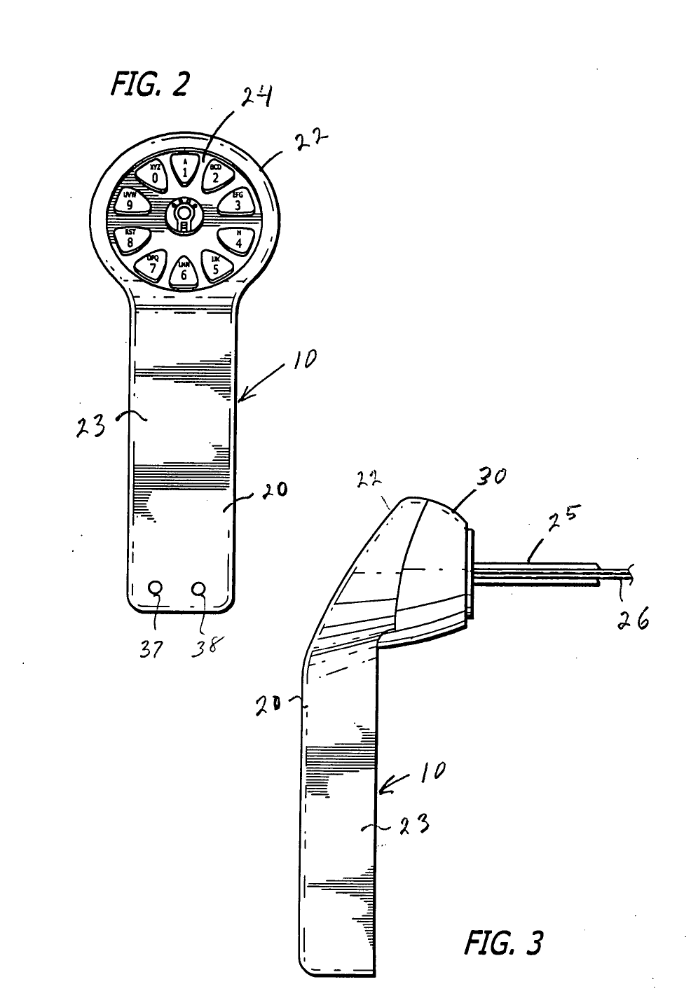

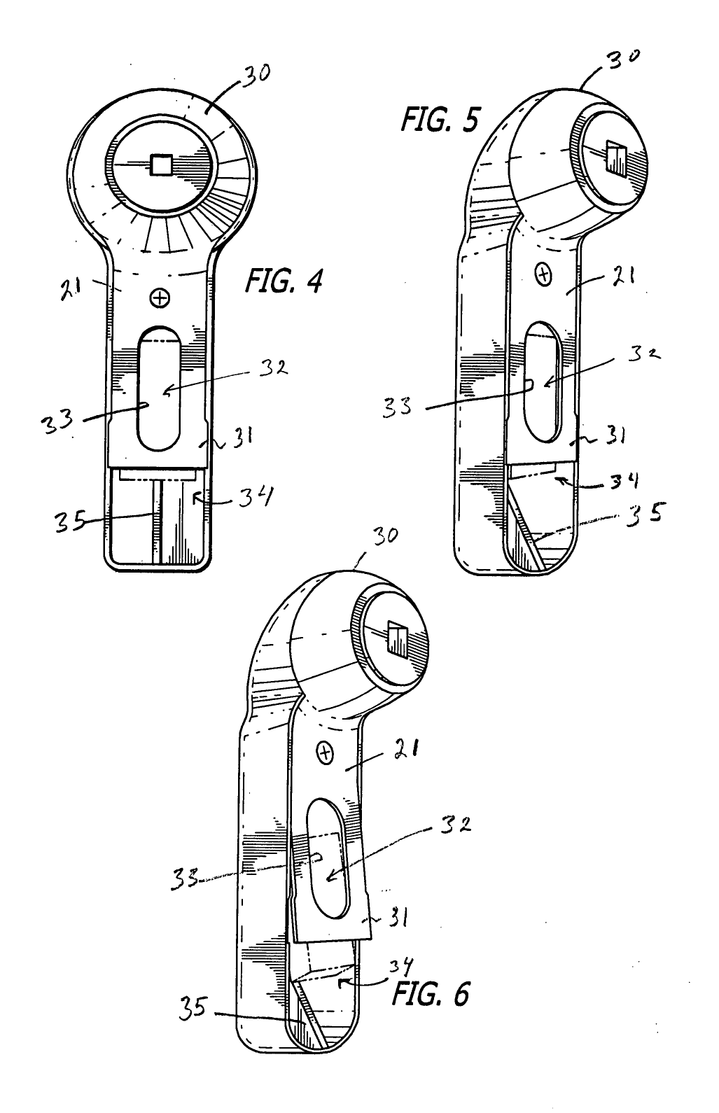

Referring now to FIGS. 2-4, applicant's exemplary handle is provided in a simple two-part construction, including a handle front shell 20 and a handle rear shell 21 (FIG. 4). Digital keypad 24 is provided for entry of an electronic lock code by the keypad in known manner. Input code is transferred through spindle 25 into the lockable container and associated electronically operated door bolt locking mechanism to unlock the door in known manner. A rectangular electrical conduit 26 may communicate the information through the spindle through the interior of the safe door. As particularly contemplated within the present invention, the digital keypad 24 is moved upwardly on the handle and mounted entirely within the handle head portion 22. This positions the keypad from the depending handle grip portion 23, which is easily available for gripping by the user without the user's hand interfering in any manner with the operation of the associated exemplary digital keypad 24. As will be understood by those skilled in the art, correct entry of a digital code through keypad 24 allows mechanical unlocking of the interior lock mechanism by simply turning depending handle 23 after entry of a correct code has placed the door lock in an unlocked condition.

The exemplary rear shell 21, as best seen in FIGS. 4-6, has an upper rear shell head portion 30, which provides for the mounting of spindle 25 and the assembly of the handle, indicated generally at 10, to the exemplary safe door 11. The current simple two-part shell construction includes a depending rear shell portion 31, which is not co-extensive with front shell 20 or handle 23. The lower end of depending shell portion 31 terminates well in advance of front shell 20 and handle 23 to provide a battery entry and retrieval opening between the shells, which will now be described. As is particularly contemplated within the present invention, the battery pack can be inserted and removed easily without the use of any tools or the manipulation of either part of the present two-part handle construction.

The insertion and removal in a simple manner of a battery pack, shown in phantom line, is illustrated in FIGS. 4-6, in association with the current rear panel construction. No additional screws, pins or tools are required for an operator to simply digitally insert or remove the battery pack. The battery housing, and location for the intended battery pack is indicated generally at 32 within the housing formed by the two-part handle construction of depending handle grip portion 23 and rear shell 21. A first battery housing aperture 33 is provided for digitally grasping an exemplary battery pack by an operator during manipulation of the pack. Second battery housing opening, indicated generally at 33, provides for the easy insertion of an exemplary battery pack of under the rear shell 21, as seen in phantom line in FIGS. 4 and 5. To facilitate the retention of an exemplary battery pack in the housing indicated generally at 32, rib 35 is provided, which must be overridden during the operation of removing the exemplary battery pack. As seen in FIGS. 4-6, rib 35 is positioned at the bottom of the open housing, within front shell 20, and has a configuration of an upwardly declining rib within the housing indicated generally at 32, appropriate electrical connectors are provided to interconnect the exemplary battery pack with the digital keypad entry mechanism. In addition, spindle mounting area 30 may be provided simply as a thin cast material cover with the front shell 20 providing interior structural mounting means for mounting the spindle 25, as discussed.

Should there be a need for connecting auxiliary electrical contacts to the battery housing, two conduction areas, 37 and 38, are provided on the exterior of the exemplary handle, indicated at 10, for inputting necessary power. The terminals of the associated battery pack can be placed in this location to provide an additional power source to recharge exemplary rechargeable batteries or battery packs inserted within said housing, indicated generally at 32.

Having thus described a preferred exemplary embodiment of the apparatus and method of the present invention, it should be understood by those skilled in the art that various modifications, adaptations and alternative embodiments thereof, may be made within the scope and spirit of the present invention, which is defined by the following claims.

1. A digital keypad actuated electronic lock having the keypad associated with a handle exteriorly of a door of a lockable container and with an electronically operated door bolt locking mechanism associated with the door interiorly of the container, said lock comprising:
a handle on an exterior of said container with a handle grip portion depending from a handle head portion;
a digitally operated keypad mounted to said handle head portion allowing an operator to grasp the handle by its grip portion without the operator's hand overlying any portions of the keypad.

2. The lock of claim 1 comprising:
A battery housing in said handle having a first battery housing aperture to allow insertion of a battery into said housing without having to open said housing and a second aperture in a portion of said housing overlying an inserted battery to allow digital contact by an operator through said second opening to move the inserted battery out of said housing through said first aperture.

3. A digital keypad actuated electronic lock having the keypad associated with a handle exteriorly of a lockable container and a electronically operated door bolt locking mechanism associated with the door interiorly of the container, said lock comprising:
a battery housing in said handle having a first battery housing aperture to allow insertion of a battery into said housing without having to open said housing and a second aperture in a portion of said housing overlying an inserted battery to allow digital contact by an operator through said second aperture to move the inserted battery out of said housing through said first opening.

4. The lock of claim 3 wherein:
said handle is on an exterior of said container and has a handle grip portion depending from a handle head portion, said housing being within said grip portion.

5. A digital keypad actuated electronic lock having the keypad associated with a handle exteriorly of a door of a lockable container and with an electronically operated door bolt locking mechanism associated with the door interiorly of the container, said lock comprising:
handle means for operating said locking mechanism:
means for mounting said handle on an exterior of said door with a handle grip portion depending from a handle head portion; and
digitally operated electronic keypad means mounted to said handle head portion for entering a locking mechanism opening code and for allowing an operator to grasp the handle by said grip portion without the operator's hand overlying any portions of the keypad.

6. The lock of claim 5 comprising:
battery housing means for storing a battery within said handle and having a first battery housing aperture means for allowing insertion of a battery into said housing without having to open said housing and a second battery housing aperture means in a portion of said housing overlying an inserted battery for allowing digital contact by an operator through said second aperture to move the inserted battery out of said housing through said first opening.

7. A safe door unlocking handle assembly having an electronic code for operating an associated electronic door lock keypad entry means, a handle, and a battery and battery housing within the handle which cooperate to facilitate opening of a locked safe door, said handle assembly comprising:
a handle front shell having means for mounting a key pad to a lead portion of said front shell and a handle grip portion depending from said head portion to a fee terminal lower end spaced from said door to facilitate grasping said handle grip portion;
including a key pad mounted code entry means on said handle head portion for entering electronic signals to operate said electronic door lock;
a spindle extending between said handle head portion and said locking mechanism through an aperture in said safe door to facilitate mechanical unlocking of said mechanism by turning of said handle after entry of a correct code has placed the door lock in an unlocked condition;
a rear shell mounted to said front shell closing rear portion of said front shell and providing a battery housing within said handle, said housing having electrical connections for electrically connecting a battery placed in said housing with said code entering means; and
first aperture means for allowing insertion of a battery into said housing without having to open said housing and second aperture means in a portion of said rear shell of said housing overlying an inserted battery for allowing digital contact by an operator through said second aperture to move the inserted battery out of said housing through said first aperture.

8. The safe handle assembly as in claim 7 wherein:
said handle front shell head portion is sufficiently remote from grip portion to facilitate an operator griping said handle grip portion with without engaging said key pad when turning said handle.

9. The safe handle assembly as in claim 7 comprising:
said second aperture therein and means for mounting said rear shell onto said front shell.

10. The safe handle assembly as in claim 7 wherein said electrical connections within said battery housing are supplemented by two conduction areas on the exterior of said handle to which terminals of another battery can be placed to provide an additional power source to recharge a rechargeable battery inserted within said housing.

11. The safe handle assembly as in claim 9 comprising:
a flange member which rests against a front face of the safe door and against which said rear shell mounted is mounted.

12. The safe handle assembly as in claim 7, wherein said handle battery housing includes an upwardly declining rib over which ribs against which said battery is inserted within said housing and which cooperates with said rear shell cover to hold an inserted battery within said housing.

13. The safe handle door unlocking handle assembly as in claim 7 wherein:
said handle has a rear shell having a rear shell head portion at an upper end thereof and a lower battery covering portion;
said rear shell covering portion having a vertically oriented oblong slot thereby providing said second aperture for digital contacting of said battery while the same is within said housing.

14. The handle assembly as in claim 13 wherein said rear shell is not coexitensive with said front shell, a lower end of said rear shell terminating above said front shell to provide a battery entry and retrieval opening between said shells which comprises said first aperture which facilitates insertion and removal from said battery relative said housing without removal of said rear shell on any portion thereof.

15. The handle assembly of claim 7 wherein:
a rib means is provided within said housing against which an inserted battery achieves a snug fit, retaining said battery in said housing until an operator moves said battery, overcoming said snug fit.

16. The handle assembly of claim 15 wherein said rib means is provided within said front shell and has an upwardly declining rib surface facing toward said door.
